(19) United States
(12) Patent Application Publication
(10) Pub. No.: US 2014/0363227 A1
(43) Pub. Date: Dec. 11, 2014

(54) Article, Interchangeable Component, And System

(71) Applicant: Patrick C. Ho, Hilton, NY (US)

(72) Inventor: Patrick C. Ho, Hilton, NY (US)

(21) Appl. No.: 13/914,103

(22) Filed: Jun. 10, 2013

(51) Int. Cl. F16B 17/00

(52) U.S. Cl. CPC F16B 17/00
USPC 403/376

(57) ABSTRACT

An article configured to secure an interchangeable component or components thereon, interchangeable components, and system for securing an interchangeable component or components to an article are disclosed. An embodiment of the system includes an article, locking unit, component support member, and interchangeable component. A tool-less attachment of the interchangeable component to the article enables the interchangeable component to be easily, quickly, and securely attached to an article, moved from one article to another, and replaced with another interchangeable component quickly.

### FIELD

This invention relates to an article, component, and system, and in particular, to an article, interchangeable component, and system for securing an interchangeable component to an article.

### BACKGROUND

The desirability of having articles with interchangeable components has long been evident in the art. For example, it is known to select matching accessories according to their appearance. Personalization of accessories allows people to exhibit their individuality and uniqueness. The interchangeability of components fulfills the desire for versatility. Therefore, articles with interchangeable components that can be easily and securely interchangeably affixed to the article by the user are desired in the art.

### SUMMARY

In accordance with one aspect of the present invention, there is provided a system for securing an interchangeable component to an article including a substrate having first and second sides and defining an aperture therethrough, the aperture having first and second ends and an edge connecting the substrate sides; a locking unit having first and second connection elements disposed at the aperture first and second ends, respectively, wherein the aperture is free of any protrusions of the locking unit; a component support member detachably secured to the substrate at least at one of the first and second ends of the aperture by the first and second connection elements; and at least one component associated with the component support member such that the at least one component is visible through the aperture from each of the first and second sides of the article, wherein the at least one component is interchangeable by tool-less attachment.

In accordance with another aspect of the present invention, there is provided an interchangeable component detachably securable to an article, including a base substantially planar in shape and having first and second sides; an edge circumscribing the base and connecting the first and second sides thereof; and two distal ends, each having an attachment member configured to detachably secure to an aperture of an article, the aperture defined therethrough, the article including a substrate having first and second sides, an edge connecting the substrate sides and first and second ends, wherein the component can be detachably secured to the article at each of the first and second ends of the aperture and the base edge mates with the aperture edge.

In accordance with another aspect of the present invention, there is provided an article for interchangeable components including a substrate having first and second sides and defining an aperture therethrough, the aperture having first and second ends and an edge connecting the substrate sides; and a locking unit having first and second connection elements disposed at the aperture first and second ends, respectively, wherein the aperture is free of any protrusions of the locking unit, and wherein the locking unit is configured to detachably secure a component support member to the substrate at least at one of the first and second ends of the aperture by the first and second connection elements.

In accordance with another aspect of the present invention, there is provided a system for securing an interchangeable component to an article including a substrate including first and second sides and defining an aperture therethrough, the aperture having first and second ends and an edge connecting the substrate sides; a locking unit including first and second connection elements disposed in a recess at the aperture first and second ends, respectively, wherein the aperture is free of any protrusions of the locking unit; a component support member configured to be secured to the substrate at the first and second ends of the aperture by the first and second connection elements, wherein the component support member is configured to be detachably secured to the substrate at least at one of the first and second ends of the aperture; and at least one component associated with the component support member such that the at least one component is visible through the aperture from each one of the first and second sides of the article, wherein the at least one component is interchangeable by tool-less attachment.

In accordance with another aspect of the present invention, there is provided an interchangeable component configured for detachably securing to an article, the component including a base substantially planar in shape and having first and second sides; an edge circumscribing the component and connecting the first and second sides thereof, wherein at least a portion of the edge includes a bevel with respect to the sides of the component; and two distal ends, each including an attachment member configured to detachably secure to a connection element at each end of a locking unit aperture of an article, the article including a substrate having first and second sides, a beveled edge connecting the substrate sides and first and second ends wherein the component can be detachably secured to the article at each end of the locking unit aperture and the bevel of the base edge mates with the bevel of the aperture edge.

In accordance with another aspect of the present invention, there is provided an article for interchangeable components including a substrate having first and second sides and defining an aperture therethrough having first and second ends, an edge circumscribing the aperture and connecting the first and second sides of the substrate; and a locking unit disposed in the substrate having first and second connection elements, each connection element having a semi-circular recess wherein the first connection element is disposed at the first aperture end and the second connection element is disposed at the second aperture end; wherein each connection element is configured to mate with a distal end of a component support member, the distal end including an elongated shape having a circular cross-section wherein at least the one of the connection elements, includes a flexible resilient material, having a semi-circular recess circumscribes at least 50% of the circular cross-section of the distal end of the component support member such that the component support member can be detachably secured by snap-fitting to the locking unit substrate at least at one of the first and second ends of the aperture.

These and other aspects of the present invention will become apparent upon a review of the following detailed description and the claims appended thereto.

### BRIEF DESCRIPTION OF THE DRAWINGS

FIG. 1 is a perspective view of an embodiment of the present invention wherein the article is a key fob;

FIG. 2 is a view of the back side of an article showing a component support member in an attached position;

FIG. 3 is a perspective view of the back side of an article showing a component support member in a partially attached position;

FIG. 4 shows an end view of an article;

FIG. 5 is a perspective view of an embodiment of the present invention wherein the article is a key fob and a plurality of interchangeable components are decorative beads;

FIG. 6 is a view of the back side of the article showing a component support member in an attached position;

FIG. 7 shows an end view of an article with attached decorative beads;

FIG. 8 is a perspective view of the back side of an article showing a component support member in a partially attached position;

FIG. 9 is a perspective view of an embodiment of the present invention wherein the article is a temple arm of an eyeglass frame;

FIG. 10 is a perspective view of an embodiment of the present invention showing a component support member;

FIG. 11 is a perspective view of an embodiment of the present invention showing a component support member and component one-piece unit;

FIG. 12 is a perspective view of an embodiment of the present invention showing a component;

FIG. 13 is a side view of an embodiment of the present invention showing the component of FIG. 12 in an entry position in a temple arm of an eyeglass frame;

FIG. 14 is a side view of an embodiment of the present invention wherein the temple arm of an eyeglass frame of FIG. 13 shows the component of FIG. 12 a locked position;

FIG. 15 is a side view of an embodiment of the present invention showing a temple arm of an eyeglass frame containing electrical connections; and

FIG. 16 is a perspective exploded view of an embodiment of the present invention wherein a locking unit substrate is attached to the article.

### DETAILED DESCRIPTION

The invention will be further illustrated with reference to the following specific embodiments. It is understood that these embodiments are given by way of illustration and are not meant to limit the disclosure or the claims to follow.

The present invention relates to an article configured to secure an interchangeable component or components thereon, interchangeable components, and system for securing an interchangeable component or components to an article. An embodiment of the system includes an article, component support member, and interchangeable component. Another embodiment of the system includes an article, locking unit, component support member, connection element, and interchangeable component. The locking unit attaches the component support member to the article. The connection element attaches the interchangeable component to the component support member, although other manners of attachment are possible. Preferably, the locking unit is composed of two connection elements, although other manners of attachment are possible. In a preferred embodiment, the locking unit connection elements are recessed within the article, as discussed more fully below. The present invention provides tool-less attachment of the interchangeable component to the article by the user. By tool-less is meant that there are no attachments of the interchangeable component to the article that can be fastened by use of a tool. This enables the interchangeable component to be easily, quickly, and securely attached to an article, moved from one article to another, and quickly replaced with another interchangeable component.

Suitable articles in accordance with the present invention include, a belt buckle, temple arm of an eyeglass frame, key fob, jewelry, hair clip, pendant, brooch, lapel pin, and the like, or any article configured to secure an interchangeable component or components thereon. Suitable components in accordance with the present invention include ornamental objects, such as decorative beads, plaques, and charms and non-ornamental objects including miniature electronic devices, such as lights, camera, speakers, or recording device and plaques incorporating such. The article can further include an attachment mechanism configured to attach the article to clothing, shoes, belts, hats, or the like. The attachment mechanism includes those know in the art, preferably, those which can easily and quickly attach and detach the article.

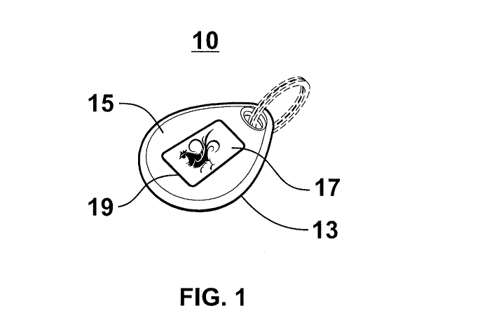

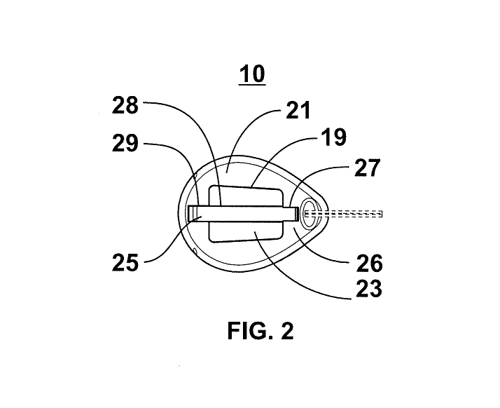

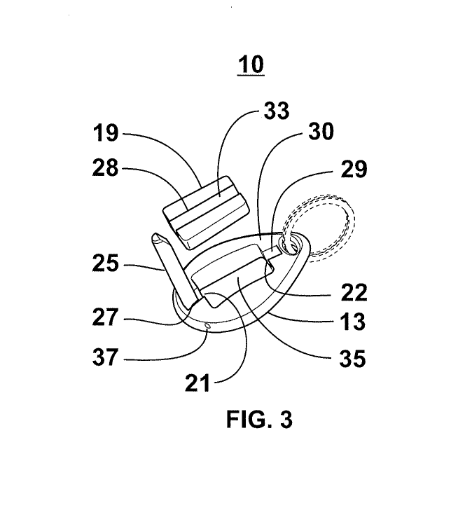

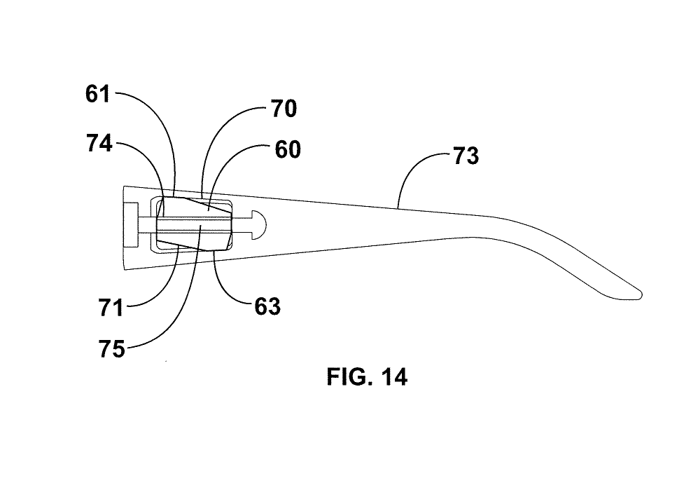

The article can be formed from a substrate body having first and second sides and defining an aperture through the substrate body, as shown by way of example at least in FIG. 3. Preferably, the aperture has first and second ends, which can be opposite or adjacent to each other. An edge circumscribes the aperture and connects the first and second sides of the substrate body. In an embodiment, the aperture edge mates with the edge of a component, as shown by way of example at least in FIGS. 1 and 2. At least portions of the edge can be straight or beveled with respect to the sides of the substrate. In an embodiment, the beveled portions of the aperture edge mate with complementary beveled portions of the edge of a component, as shown by way of example at least in FIGS. 3 and 14. The substrate can be made from any material, for example, plastic, metal, ceramic, composite, or the like. The aperture can define any shape through the substrate, for example, circular, oval, square, rectangular, or irregular shape.

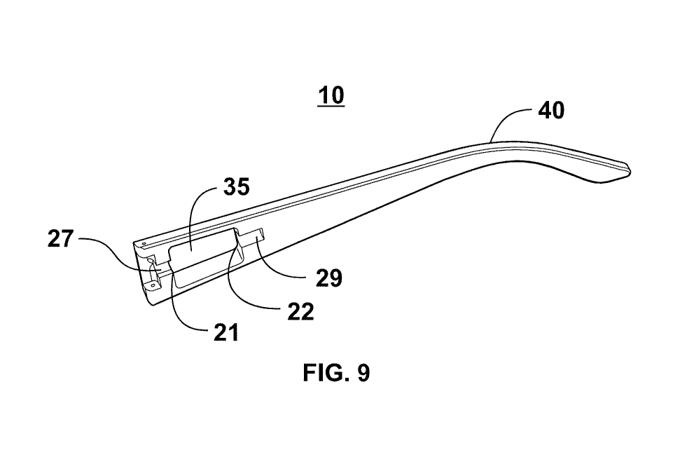

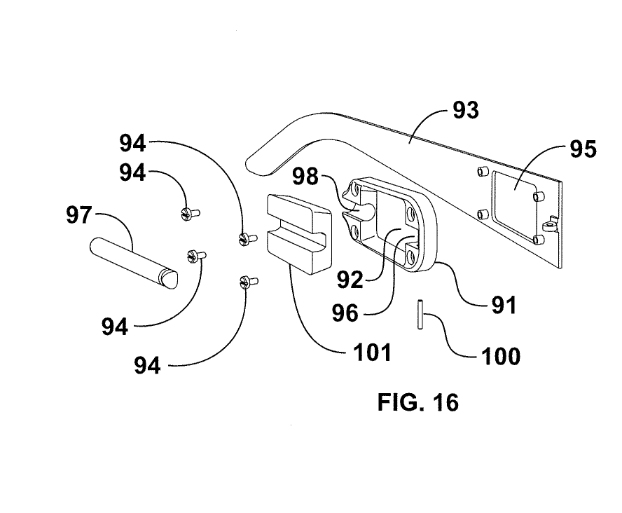

The locking unit can be formed from the substrate that forms the article, as shown by way of example at least in FIG. 3. The locking unit can be formed from a substrate that is a separate piece and attached to the article, as shown by way of example at least in FIG. 16. Preferably, the locking unit includes an attachment at least at each of the first and second ends of the aperture. More preferably, each attachment of the locking unit is composed of a connection element. Preferably, the locking unit is made from a flexible, resilient material. In a preferred embodiment, the locking unit is recessed within the substrate about the aperture. In an embodiment, the aperture is free of any attachment members or protrusions which extend into the aperature. In this regard, the connection element of the locking unit does not protrude into the aperture, as shown by way of example at least in FIG. 3. Other configurations and manners of construction are possible. In an embodiment, the locking unit is recessed within the substrate about the aperture such that there are no attachment members or protrusions which extend above the surface of the substrate, as shown by way of example at least in FIG. 9.

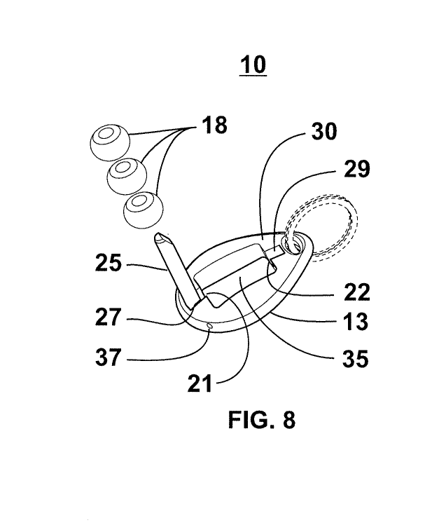

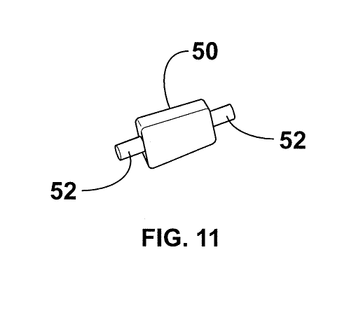

In an embodiment, the component support member is configured to be secured to the article by the locking unit. Preferably, the component support member is secured to the substrate body at the first and second ends of the aperture by the locking unit. Preferably, the locking unit can detachably secure or pivotally secure a member to the substrate body by the connection element. In an embodiment, the component support member is detachably secured to the substrate body at least at one of the ends of the aperture. The component support member can be detachably secured to the substrate body at each end of the aperture, for example, by a connection element at each end of the substrate aperture. When the component support member is detachably secured at each end thereof to the substrate body, the component support member can be completely detached from the substrate body to allow interchanging of the components. Similarly, when the component support member and component form a one-piece unit, as shown by way of example at least in FIG. 11, the unit can be completely detached from the substrate body to allow interchanging of one-piece units. In another embodiment, the component support member is pivotally secured to the substrate body at one end of the aperture. More preferably, the component support member is detachably secured to the substrate body at one end of the aperture and pivotally secured to the substrate body at the other end of the aperture, as shown by way of example at least in FIGS. 3 and 8. The component support member can be easily and efficiently attached and detached from the substrate body by hand.

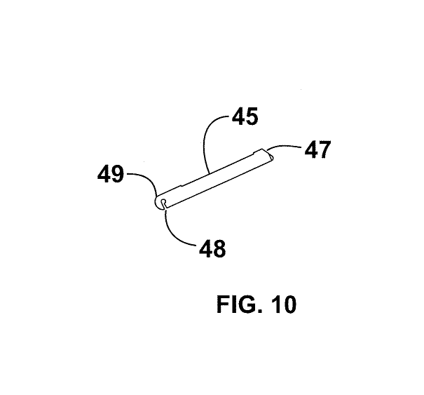

The component support member can be any shape which can attach to the locking unit of the substrate body. Preferably, the component support member is elongated, as shown by way of example at least in FIG. 10. The component support member can be a post. In a preferred embodiment the component support member is elongated and beveled at one end to facilitate easy detachment from being detachably secured the substrate body. The support member can be detached from the substrate body by hand, or the support member can be detached from the substrate body, for example, by a pointed implement, such as a pen tip. In another embodiment the component support member is elongated and pivotally secured to the substrate at another end of the aperture. The cross-section of the component support member can be any shape. Preferably, the cross-section of the component support member is generally circular. In an embodiment, the component support member has an effective cross-sectional diameter in a range between about 3 mm and about 5 mm, more preferably an effective cross-sectional diameter of about 4 mm.

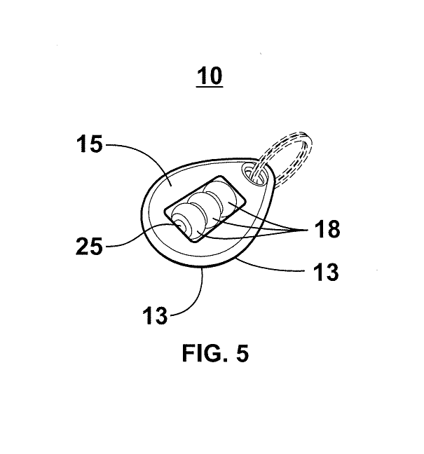

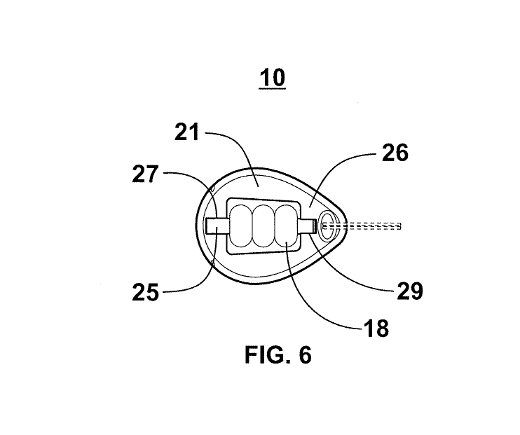

At least one component can be associated with the component support member. The at least one component can be associated with the component support member in a number of different manners. The component support member is configured to secure at least one interchangeable component thereon. Preferably, a plurality of components can be secured to the component support member. In an embodiment, when an ornament is secured to the support member and the support member is secured to the substrate body, the ornament is disposed in the article aperture. In a preferred embodiment, at least one component can be detachably secured to the component support member. Preferably, a plurality of components can be detachably secured to the component support member and visible in the article aperture as seen from each side of the article when the component support member is secured to the substrate body, as shown by way of example at least in FIGS. 5 and 6.

In an embodiment of the present invention, the components have an opening therethrough. Preferably, the components are decorative ornaments having an opening therethrough. Preferably, the ornament is a decorative bead, and more preferably the ornament is a plurality of decorative beads, as shown by way of example at least in FIG. 8. The component support member is disposed through the component opening and configured to secure the component thereon in an interchangeable manner. Preferably, the component or the plurality of components is visible from each of the first and second sides of the article. The shape and size of the cross-section of the component support member can be complementary to the shape and size of the component opening. The opening of the component can be any shape. Preferably, the component opening and the cross-section of the component support member are both circular and sized so the component can be secured on the component support member. Preferably, the component opening has a diameter in a range between about 3 mm and about 5 mm, more preferably a diameter of about 4 mm.

In another embodiment of the present invention, the component is substantially planar and has first and second sides. By way of example, the substantially planar component can be a plaque, as shown at least in FIG. 3. Preferably, an edge circumscribes the substantially planar component and connects the first and second sides thereof. Preferably, the component has a perimeter which is configured to mate with the perimeter of the article aperture. At least portions of the edge can be straight or beveled with respect to the sides of the component. The first side can have a decorative surface. When the component is secured to the component support member, the decorative surface of the first side is visible from only one side of the article. In an embodiment, the second side of the component is configured to fit together with the component support member. In an embodiment, the component is configured to be able to fit together in a mating fashion with the component support member to form an integral unit. In an embodiment, the second side of the component is configured to fit together with the component support member by detachably securing to the component support member. By way of example, the component can be detachably secured to the component support member by a connection element. Preferably, the connection element is made from a flexible, resilient material. In an embodiment, the plaque is visible in the article aperture as seen from each side of the article, as shown by way of example at least in FIGS. 1 and 2.

As noted above, the second side of the component can be configured to detachably secure to the component support member by a connection element disposed on the second side of the component, as shown by way of example at least in FIG. 3. More preferably, the component support member is elongated and has a cross-section circular in shape and sized to fit within the recessed portion of the connection element disposed on the second side of the component. In a preferred embodiment of the present invention the component support member includes a post having a circular cross-section and the component second side connection element is composed of a flexible, resilient material having a semi-circular recess configured to mate with the component support member post to detachably secure to the component support member wherein the semi-circular recess circumscribes at least 50% of the circular cross-section of the component support member post such that the component support member is detachably secured to the component second side to provide a snap-fit attachment. In another embodiment, for example, wherein the component is restricted from being pushed through one side of the aperture due to the complementary beveling of at least a portion of the edges of both the component and the aperture, a connection element on the other side of the component need only be configured to be able to fit together in a mating fashion to the component support member.

In another embodiment, the component support member and associated component or components are formed from a single piece, as shown by way of example at least in FIG. 11. Preferably, the component support member and associated components form a one-piece unit having two distal ends each having an attachment member which can be detachably secured to the article at each end of the aperture, for example by the locking unit.

In an embodiment, the component has four corners defined by the edge, wherein at least portions of the edge can be straight or beveled with respect to the sides of the component. As shown by way of example at least in FIG. 3, the opposing pair of component edges perpendicular to the channel 33 are not beveled and are configured to mate with the corresponding opposing pair of non-beveled edges of the substrate aperture 35. Likewise, the opposing pair of component edges parallel to the channel 33 are beveled and are configured to mate with the corresponding opposing pair of beveled edges of the substrate aperture 35. Other manners of corresponding beveled and non-beveled edges are possible. In an embodiment, at least one pair of opposite edges is beveled such that the perimeter of one side of the component is larger than the perimeter of the other side of the component. In such an embodiment, the edge of the article aperture is beveled in a complementary manner to the component so as to be able to fit together in a mating fashion. Preferably, the side of the component configured to detachably secure to the component support member is the component side having the larger edge perimeter. In such an embodiment, since the component is restricted from being pushed through one side of the aperture by the component side having the larger perimeter due to the beveling, the other side of the component need only be configured to be able to fit together in a mating fashion to the component support member. In another embodiment, the component support member and component are formed from a single piece. Preferably, the component support member and associated component form a one-piece unit which can be detachably secured to the substrate body at each end of the aperture.

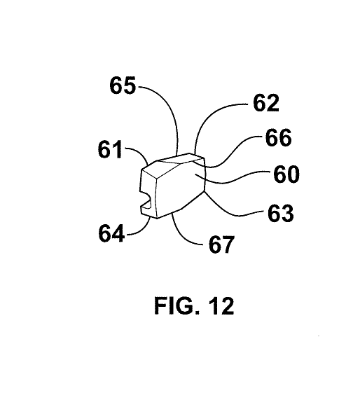

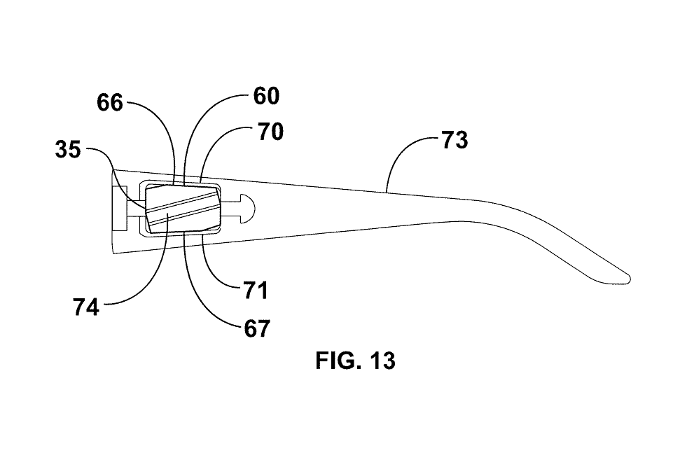

In another embodiment, the component has a perimeter which is configured to at least partially mate with the perimeter of the substrate aperture. In this embodiment, the component has four corners defined by an edge which connects the sides of the component, wherein portions of at least two opposite corners of the edge are beveled and the remaining portions of those edges are straight with respect to the sides of the component, as shown by way of example at least in FIG. 12. The at least one pair of opposite straight edges of the component is configured such that the perimeter of the component fits in the substrate aperture having at least one pair of opposing sides of the aperture beveled with respect to the sides of the substrate to form an entry position, as shown by way of example at least in FIG. 13. The support member mating side of the component is configured to fit together with the component support member when the component is rotated within the substrate from the entry position to a locking position. Upon rotation, the side of the component configured to detachably secure to or mate with the component support member is aligned with the support member. In the locking position, the edge of the substrate aperture is beveled in a complementary manner to the component beveled corner so as to be able to fit together in a mating fashion, as shown by way of example at least in FIG. 14. In this embodiment, since the component is restricted from being pushed through the aperture due to the beveling of the locking position, the other side of the component need only be configured to be able to fit together in a mating fashion to the component support member. In another embodiment, the support member mating side of the component is configured to detachably secure to the component support member.

In an embodiment of the present invention the connection element is configured to attach to the component support member. Preferably, the connection element is disposed in the substrate body at each end of the substrate aperture to form the locking unit, as shown by way of example at least in FIG. 2. In an embodiment, the connection element includes a substantially planar base having a recess in the surface thereof and made from a flexible and resilient material. Preferably the recess has a concave shape, and is configured to mate with a distal end of the component support member. In an embodiment, the distal end of the component support member is provided with a bevel which mates with a complementary bevel surface of the substrate connection element to facilitate ease of detachment. Preferably, the component support member is elongated and has a cross-section circular in shape and sized to fit within the recessed portion of the connection element. Preferably, the recessed portion of the connection element is C-shaped. More preferably, the concave shape of the recess is semi-circular and circumscribes at least 50% of the circular cross-section of the component support member such that the component support member is detachably secured to the connection element. Preferably, the effective diameter of the semi-circular recess is in a range between about 3 mm and about 5 mm, more preferably the effective diameter is about 4 mm. The planar base is preferably made of flexible, resilient, fatigue resistant material capable of withstanding repeated bending without failure. Preferably, the component support member is releasably attached to the connection element by frictional engagement. In a preferred embodiment, the semi-circular recess of the connection element circumscribes slightly more than 50% of the circular cross-section of the component support member such that the component support member is detachably secured to the connection element by a snap-fitting. In another embodiment, the recessed portion of the connection element is provided with a magnet which magnetically attracts a magnet disposed in an end of the component support member such that the component support member is detachably secured to the connection element by magnetic interaction. Preferably, the component support member can be selectively engaged or disengaged from the connection element by the application of pressure on the support member.

In another embodiment, the connection element includes a pivotable hinge mounted to the article body and configured to attach to one end of the component support member. Preferably, the connection element is disposed on the article at one end of the aperture so that the component support member hingedly swings between a partially attached position and an attached position. In an embodiment, the component support member is elongated, for example, a post that is pivotally secured to the substrate at one end of the aperture by, for example, a pin disposed through one end of the component support member, and wherein each end of the pin is secured in the substrate body, as shown by way of example at least in FIGS. 3 and 8. In an embodiment, the component support member has a hole disposed through a distal end thereof that is configured to accept the pin in a manner to pivotally secure the end of the component support member to the substrate at one end of the aperture. In another embodiment, the component support member has a channel transversely disposed in a distal end thereof that is configured to accept the pin in a manner to pivotally secure the end of the component support member to the substrate at one end of the aperture, as shown by way of example at least in FIG. 10. In such a configuration, the component support member can be detachably secured to the pin without removing the pin from the substrate. For example, the channel of the component support member can engage the pin by sliding the component support member into the connection element recess and securing the distal end about the pin. Other configurations of the component support member and pivotable hinge and manners of providing a pivotable connection are possible. The component support member can be swung between an attached position where the component support member is at least partially disposed in the aperture with at least one component disposed thereon and a partially attached position which allows access to the component support member for the interchangeable selection of components.

FIG. 1 shows an embodiment of the present invention wherein the article 10 is a key fob. A substrate body 13 has a front side 15 which shows a decorative surface 17 of an interchangeable component 19, shown as a plaque in FIG. 1.

FIG. 2 shows a back side 21 of the article 10. A component support member 25 is shown in an attached position 26 pivotally attached to the substrate body by a first connection element 27 and detachably secured to the substrate body by a second connection element 29. A back side 23 of the plaque component 19 is shown attached to the component support member 25 by a third connection element 28.

FIG. 3 shows the component support member 25 in a partially attached position 30, which is opened and not attached to the connection element 29, for ease of attachment of the third connection element 28 to the component support member 25. The component 19 can be placed in substrate aperture 35 prior to attachment to the component support member 25. The component 19 is shown in FIG. 3 as a plaque having a pair of opposite edges beveled. The substrate aperture 35 is shown having opposite edges beveled so as to mate with the corresponding beveled edges of the plaque. A pin 37 of the first connection element 27 is secured in the substrate body 13 and shown disposed through an end of the component support member 25 for a pivotable attachment of the component support member 25 to the substrate body 13. The first connection element 27 is disposed at a first end 21 of the aperture 35 and the second connection element 29 is disposed at a second end 22 of the aperture 35. The component support member 25 is configured to be detachably secured to the substrate body 13 by the second connection element 29. The channel 33 of the component 19 can be configured to mate with the component support member 25 so as to hold the component 19 into place in the article.

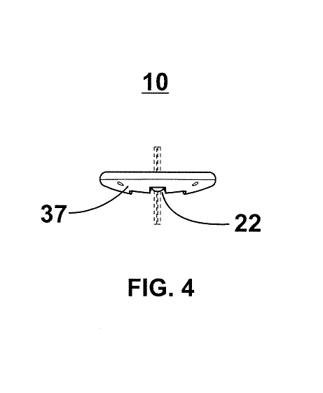

FIG. 4 shows an end view of the article 10 with an attached plaque component. The component support member 25 is attached to the substrate body 13 and shown in the attached position.

FIG. 5 shows an embodiment of the present invention wherein the article 10 is a key fob. A substrate body 13 has a front side 15 which shows a plurality of interchangeable components 18, in this case decorative beads, attached to the component support member 25.

FIG. 6 shows a back side 21 of the article 10. A component support member 25 is shown in an attached position 26 pivotally attached to the substrate body by a first connection element 27 and detachably secured to the substrate body by a second connection element 29. A plurality of interchangeable components 18, in this case decorative beads, is attached to the component support member 25 and visible from the back side 21 of the substrate body.

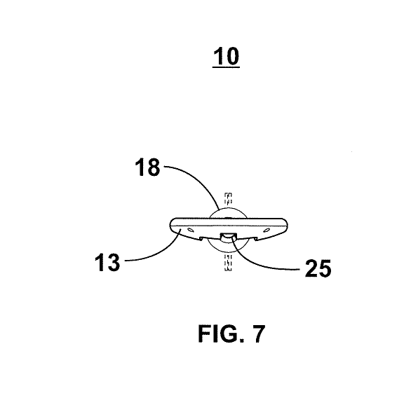

FIG. 7 shows an end view of the article 10. The component support member 25 is attached to the substrate body 13 and shown in the attached position. An end component of the plurality of interchangeable components 18 attached to the component support member 25 is visible from the end view.

FIG. 8 shows the component support member 25 in a partially attached position 30, which is opened and not attached to the connection element 29, for ease of attachment of the plurality of the interchangeable components 18, in this case decorative beads, to the component support member 25. A pin 37 of the first connection element 27 is secured in the substrate body 13 and shown disposed through an end of the component support member 25 for a pivotable attachment of the component support member 25 to the substrate body 13. The components 18 can be placed on the component support member 25 and pivoted into the substrate aperture 35 prior to detachably securing the component support member 25 to the substrate body 13 by the second connection element 29.

FIG. 9 shows one embodiment of the present invention wherein the article 10 is a temple arm 40 of an eyeglass frame. The first connection element 27 is disposed at the first end 21 of the aperture 35 and the second connection element 29 is disposed at the second end 22 of the aperture 35 in a recessed fashion, as shown on the inside of the temple arm 40. As can be seen, the aperture 35 is free of any attachment members or protrusions which extend into the aperature. Preferably, the first and second connection elements 27 and 29 are configured to detachably secure a component support member having an interchangeable component to the temple arm 40 or to detachably secure a one-piece support member/component unit to the temple arm 40.

FIG. 10 shows an embodiment of the present invention wherein a component support member 45 has a beveled end 47 and a transverse channel 48 at the other end 49. The transverse channel 48 forms a detachable connection which is configured to accept the substrate pin 37 in a manner to pivotally secure the end 49 of the component support member 45 to the substrate at one end of the aperture. In another embodiment from that shown in FIG. 10, in place of the transverse channel 48, the component support member has a hole disposed through a distal end thereof that is configured to accept the pin in a manner to pivotally secure the end of the component support member to the substrate at one end of the aperture. As shown in FIG. 10, the beveled end 47 is configured to detachably secure to the substrate at the other end of the aperture. In a preferred embodiment the component support member is elongated and the beveled end facilitates easy detachment from the substrate body. For example, the support member can be detached from the substrate body by hand by the user or by a pointed implement, such as a pen tip.

FIG. 11 shows an embodiment of the present invention wherein a component support member and component form a one-piece unit 50. In an embodiment, distal ends 52 are configured to detachably secure to connection elements of the substrate. In another embodiment, a distal end 52 is configured to pivotally attach to a connection element of the substrate. In a further embodiment, the distal ends 52 can be formed from a component support member that is a separate piece from the component plaque.

Referring to FIGS. 12-14 in another embodiment, the component 60 has a perimeter which is configured to at least partially mate with the perimeter of the substrate aperture 35. In such an embodiment, the component 60 has four corners 61, 62, 63, 64 defined by the edge 65, which connects the sides of component 60, wherein portions of two opposite corners 61, 63 of the edge 65 are beveled and the remaining portions 66, 67 of those edges are straight with respect to the sides of the component 60. As shown in FIG. 13, the pair of opposite straight edges 66, 67 of the component 60 is configured such that the perimeter of the component 60 fits in the substrate aperture 35 having at least one pair of opposing sides 70, 71 of the aperture 35 beveled with respect to the sides of the substrate 73, in this example a temple arm of an eyeglass frame, to form an entry position. The support member mating side 74 of the component 60 is configured to fit together with the component support member 75 when the component 60 is rotated within the substrate 73 from the entry position to a locking position, as shown in FIG. 14. Upon rotation, the side 74 of the component 60 configured to detachably secure to the component support member 75 is aligned with the support member 75. In the locking position, the edges 70, 71 of the aperture 35 are beveled in a complementary manner to the component 60 beveled corners 61, 63 so as to be able to fit together in a mating fashion. In such an embodiment, since the component 60 is restricted from being pushed through the aperture 35 due to the beveling of the locking position, the other side 74 of the component 60 need only be configured to be able to fit together in a mating fashion to the component support member 75.

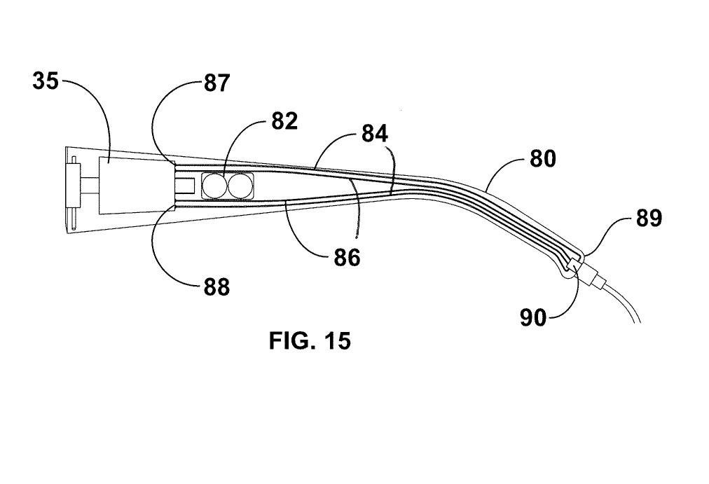

FIG. 15 shows a temple arm of an eyeglass frame article 80 having battery compartment 82 adjacent the aperture 35. The battery compartment 82 is configured to provide electrical connection through electrical wires 86 between the battery compartment 82 and the aperture 35, for example, so as to allow powering of electrical components disposed within or attached to the component placed in the aperture 35. Electrical wires 86 on the other side of the battery compartment provide electrical connection between the battery compartment 82 and electrical plug 90, for example, for recharging batteries disposed in the battery compartment 82. Electrical wires 84 provide electrical connection between the contacts 87 and 88, disposed in the aperture 35, and the distal end 89 of the article 80, for example, for powering accessories not requiring power from the battery compartment 82, such as headphones and headsets. The distal end 89 contains an electrical plug 90, for example, for electrical connection to such remote devices.

FIG. 16 shows a perspective exploded view of an embodiment of the present invention wherein a substrate 91 forms a locking unit 92. The substrate 91 is attached to a temple arm 93 of an eyeglass frame article by the screws 94. The aperture 95 of temple arm 93 is aligned with the aperture 96 of the substrate 91. The component support member 97 is detachably secured to the substrate body 91 at one end 98 of the aperture 96 and pivotally secured to the substrate body 91 at the other end 99 of the aperture 96 by securing pin 100. Component 101 is configured to fit in aperture 96 of the substrate and be secured by the component support member 97 and locking unit 92 in a tool-less fashion.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A system for securing an interchangeable component to an article comprising:
an article comprising a substrate comprising first and second sides and defining an aperture therethrough, the aperture having first and second ends and an edge connecting the substrate sides;
a locking unit comprising first and second connection elements disposed at the aperture first and second ends, respectively, wherein the aperture is free of any protrusions of the locking unit;
a component support member detachably secured to the substrate at least at one of the first and second ends of the aperture by the first and second connection elements; and
at least one component associated with the component support member such that the at least one component is visible through the aperture from each of the first and second sides of the article, wherein the at least one component is interchangeable by tool-less attachment.

2. The system of claim 1, wherein the component support member is pivotally secured to the substrate at one end of the aperture by a connection element of the locking unit.

3. The system of claim 1, wherein the at least one component comprises an opening therethrough, wherein the component support member is disposed through the component opening.

4. The system of claim 1, wherein the at least one component is detachably secured to the component support member.

5. The system of claim 1, wherein the at least one component fits together in a mating fashion with the component support member.

6. The system of claim 1, wherein the component support member and at least one component form a one-piece unit.

7. The system of claim 1, wherein the at least one component is substantially planar and comprises first and second sides, wherein the second side is configured to detachably secure to the component support member.

8. The system of claim 1, wherein the component support member comprises an elongated shape having a circular cross-section and a portion of the substrate at the first end of the aperture comprises a flexible material having a semi-circular recess configured to mate with the component support member wherein the semi-circular recess circumscribes at least 50% of the circular cross-section of the component support member such that the component support member is detachably secured to the substrate at the first end of the aperture.

9. The system of claim 8, wherein the component support member is pivotally secured to the substrate at the second end of the aperture.

10. The system of claim 1, wherein the at least one component perimeter is configured to mate with the edge of the substrate aperture.

11. The system of claim 10, wherein the at least one component comprises a perimeter edge having a bevel which mates with a bevel edge of the substrate aperture.

12. The system of claim 1, wherein the substrate comprises an electrical connection between a battery compartment disposed in the substrate, electrical contacts disposed in the substrate aperture and wires disposed through the substrate.

13. The system of claim 1, wherein the article comprises a temple arm of an eyeglass frame, belt buckle, piece of jewelry, hair clip, pendant, brooch, lapel pin, or key fob.

14. The system of claim 1, wherein the article is a piece of jewelry and further comprises an attachment mechanism configured to attach to a piece of clothing, belt, shoe, or hat.

15. An interchangeable component detachably securable to an article, comprising:
a base substantially planar in shape and having first and second sides;
an edge circumscribing the base and connecting the first and second sides thereof; and
two distal ends, each comprising an attachment member configured to detachably secure to an aperture of an article, the aperture defined therethrough, the article comprising a substrate having first and second sides, an edge connecting the substrate sides and first and second ends, wherein the component can be detachably secured to the article at each of the first and second ends of the aperture and the base edge mates with the aperture edge.

16. The interchangeable component of claim 15, wherein at least a portion of the base edge comprises a bevel with respect to the sides of the component, which mates with a bevel of an edge of the aperture.

17. The interchangeable component of claim 15, wherein the two distal ends comprise a component support member as a separate piece from the component base.

18. An article for interchangeable components comprising:
a substrate comprising first and second sides and defining an aperture therethrough, the aperture having first and second ends and an edge connecting the substrate sides;
and a locking unit having first and second connection elements disposed at the aperture first and second ends, respectively, wherein the aperture is free of any protrusions of the locking unit, and wherein the locking unit is configured to detachably secure a component support member to the substrate at least at one of the first and second ends of the aperture by the first and second connection elements.

19. The article of claim 18, wherein each connection element comprises a flexible material having a semi-circular recess wherein the first connection element is disposed at the first aperture end and the second connection element is disposed at the second aperture end;
wherein each connection element is configured to mate with a distal end of the component support member, the distal end comprising an elongated shape having a circular cross-section wherein the connection element semi-circular recess circumscribes at least 50% of the circular cross-section of the distal end of the component support member such that the component support member can be detachably secured to the locking unit substrate at each of the first and second ends of the aperture.

20. An article for interchangeable components comprising:
a temple arm of an eyeglass frame having a first aperture therethrough and;
a substrate detachably secured to the temple arm, the substrate comprising first and second sides and defining a second aperture therethrough, wherein the first aperture is aligned with the second aperture, the second aperture having first and second ends and an edge connecting the substrate sides, and being configured to detachably secure an interchangeable component to the substrate.

21. The article of claim 20, wherein the substrate comprises a locking unit having first and second connection elements disposed at the second aperture first and second ends, respectively, wherein the second aperture is free of any protrusions of the locking unit, and wherein the locking unit is configured to detachably secure the interchangeable component to the substrate at least at one of the first and second ends of the second aperture by at least one of the first and second connection elements.

22. The article of claim 21, wherein the interchangeable component is configured to detachably secure to a component support member wherein the component support member is configured to detachably secure to the substrate at least at one of the first and second ends of the second aperture by at least one of the first and second connection elements.

23. The article of claim 22, wherein each connection element comprises a flexible material having a semi-circular recess wherein the first connection element is disposed at the first aperture end and the second connection element is disposed at the second aperture end; wherein the component support member comprises two distal ends and each connection element is configured to mate with a distal end of the component support member, the distal end comprising an elongated shape having a circular cross-section wherein the connection element semi-circular recess circumscribes at least 50% of the circular cross-section of the distal end of the component support member such that the component support member can be detachably secured to the locking unit substrate at each of the first and second ends of the aperture.
